(19) United States
(12) Patent Application Publication
(10) Pub. No.: US 2010/0078412 A1
(43) Pub. Date: Apr. 1, 2010

(54) Hybrid welding method

(75) Inventors: Fernando Martinez Diez, Dunlap, IL (US); Huijun Wang, Peoria, IL (US); Howard W. Ludewig, Groveland, IL (US); Keith M. Egland, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 12/285,216

(22) Filed: Sep. 30, 2008

(51) Int. Cl. B23K 26/20

(52) U.S. Cl. 219/121.64; 219/121.63

(57) ABSTRACT

A welding method is disclosed. The welding method includes making a weld via laser-arc hybrid welding. The welding method also includes using a fiber laser source in the laser-arc hybrid welding.

### TECHNICAL FIELD

The present disclosure is directed to a welding method and, more particularly, to a hybrid welding method.

### BACKGROUND

Lasers are used in numerous industrial applications such as, for example, laser welding. A laser typically includes a pump source, a gain medium, and a mirror system. The pump source imparts energy to excite atoms of the gain medium. The excited atoms may then relax, emitting photons (i.e., light energy). The photons are reflected by the mirror system and travel repeatedly through the gain medium, concentrating the light energy. Stimulated emission may occur, where the photons affect atoms of the gain medium to emit additional photons having identical wavelength and phase, thereby producing laser light. A mirror of the laser may be partially reflective, allowing laser light to be emitted from the laser and used in an industrial application such as, for example, laser welding.

U.S. Patent Application Publication 2005/0011868 A1 (the '868 publication), by Matile et al., discloses a hybrid laser-arc welding method. The welding method of the '868 publication includes welding via a welding head including a laser and an electric arc. The '868 publication discloses using a YAG or CO₂ laser.

Although the welding method of the '868 publication may provide a method for laser welding, the laser may not adjust to account for mismatch of work pieces. Additionally, the uneven energy distribution of a YAG or CO₂ laser may negatively affect weld quality by focusing too much energy on certain portions of a weld and too little energy on other portions. Specifically, the laser disclosed in the '868 publication may allow the laser beam to shoot through a gap between work pieces to be welded, negatively affecting weld quality.

The present disclosure is directed to overcoming one or more of the shortcomings set forth above and/or other deficiencies in existing technology.

### SUMMARY OF THE DISCLOSURE

In accordance with one aspect, the present disclosure is directed toward a welding method. The method includes making a weld via laser-arc hybrid welding. The method also includes using a fiber laser source in the laser-arc hybrid welding.

According to another aspect, the present disclosure is directed toward a welding system. The welding system includes a laser-arc hybrid welder including a laser welder coupled to an arc welder. The welding system also includes a fiber laser source.

### BRIEF DESCRIPTION OF THE DRAWINGS

FIG. 1 is a diagrammatic illustration of an exemplary welding system;

FIG. 2 is a diagrammatic illustration of a laser of the welding system of FIG. 1;

FIG. 3 is a cross-sectional illustration of a weld joint before welding, viewed along line A-A of FIG. 1;

FIG. 4 is a flow chart of an exemplary disclosed welding method; and

FIG. 5 is a cross-sectional illustration of a weld, viewed along line B-B of FIG. 1.

### DETAILED DESCRIPTION

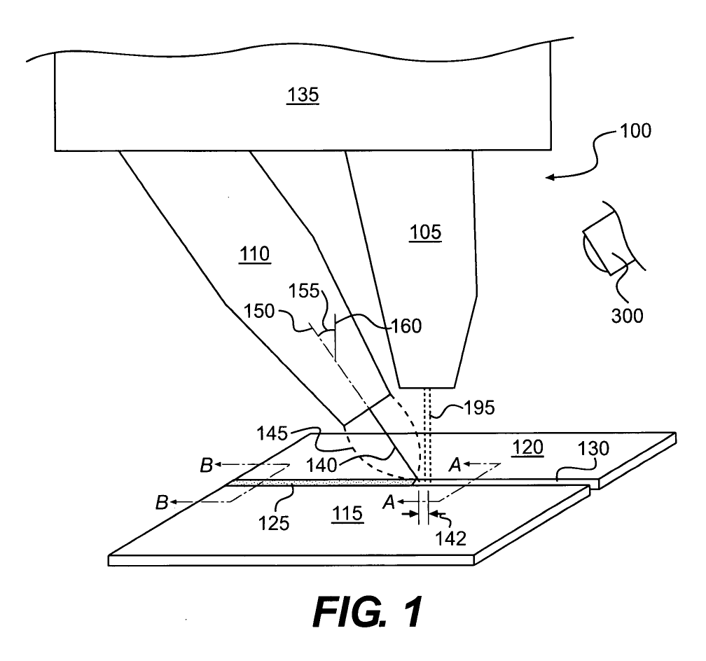

FIG. 1 illustrates an exemplary welding system 100. Welding system 100 may be a hybrid laser-arc welding system that includes a laser welder 105 and an arc welder 110. Welding system 100 may be used to weld work pieces 115 and 120 together via a weld 125.

Work pieces 115 and 120 may be any suitable materials for welding such as, for example, steel plates. Work pieces 115 and 120 may be between about 6 and 12 mm thick. Work pieces 115 and 120 may be placed against each other so as to leave no gap, or may be separated by a gap 130. Gap 130 may be about 1 mm or less in width. For example, gap 130 may be about ¼ mm to about ¾ mm in width, or about ½ mm or less in width. Weld 125 may be any suitable weld type such as, for example, a butt-weld joining work pieces 115 and 120.

Laser welder 105 and arc welder 110 may be separate welders mounted in separate places, or may be mounted on a single mount 135. Mount 135 may be moved at a suitable rate of movement for welding such as, for example, between about 1 and 2 meters/minute. Depending on welding conditions, either laser welder 105 or arc welder 110 may lead. Welding effects of laser welder 105 and arc welder 110 may be separated by a WLBD 142 (wire-to-laser-beam distance) of between about 0 and 20 mm. A position of laser welder 105 and arc welder 110 may vary during a welding process to generally match a change in position of work pieces 115 and 120 to be joined. The position of laser welder 105 and arc welder 110 may be controlled via automated programming. The programming of laser welder 105 and arc welder 110 may be adjusted during the welding process based on the change in position of work pieces 115 and 120.

Camera 300 may measure the conditions of a joint to be welded through the use of laser or visible spectrum technology. Measurements may be of gap 130 and any mismatch in alignment of work pieces 115 and 120. Upon measurement of the conditions of work pieces 115 and 120, the camera may feed information to laser welder 105 and/or arc welder 110 to change the welding conditions and/or the relative positioning in order to satisfy the changes. This may happen continuously during the welding process.

Arc welder 110 may be a gas metal arc welder (GMAW), also known as a metal active gas (MAG) welder. Arc welder 110 may include a consumable wire electrode 140 for generating a weld arc 145. Weld arc 145 may melt work pieces 115 and 120 and electrode 140 to make weld 125. A centerline 150 of arc welder 110 may be positioned at an angle 155 from an axis 160, where axis 160 is perpendicular to work pieces 115 and 120. Angle 155 may be any suitable angle for GMAW such as, for example, between about 20 and 45 degrees. Arc welder 110 may also emit shielding gas for protecting weld 125 during welding such as, for example, carbon dioxide.

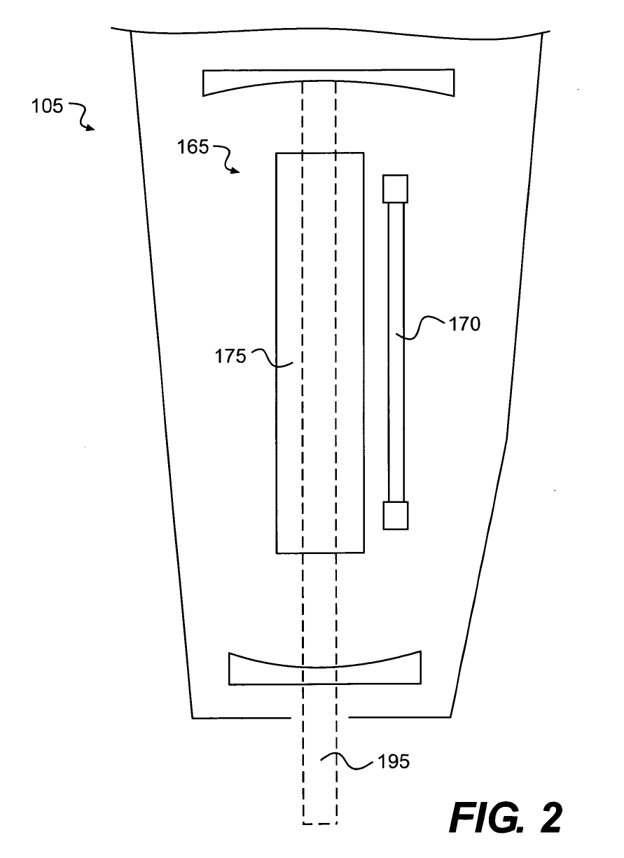

As illustrated in FIG. 2, laser welder 105 includes a laser 165. Laser 165 may operate at a suitable power level for welding such as, for example, between about 4 and 20 kW. For example, laser 165 may operate at between about 6.5 and 7.0 kW. Laser 165 may be a fiber laser and may include a pump source 170 and a gain medium 175. Pump source 170 may be a diode laser. Pump source 170 may excite atoms of gain medium 175. Gain medium 175 may become excited and then release the imparted energy as photons. The photons may be reflected repeatedly between rare-earth-element (e.g., ytterbium, erbium, praseodymium, and/or thulium) doped fiber glass. The photons may then be emitted from an end of the doped fiber glass as a laser beam 195. Stimulated emission may occur, in which the photons may affect additional photons, all having similar phase and wavelength properties, to be released.

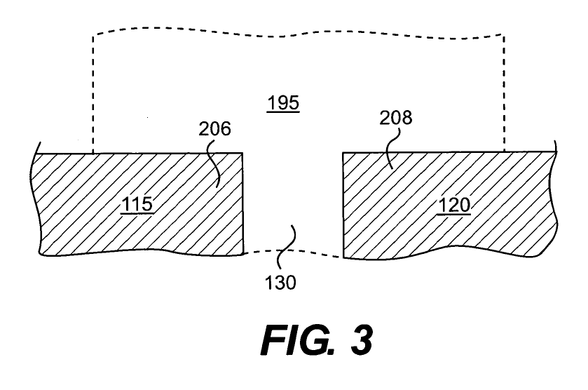

Gain medium 175 is a fiber laser source. Gain medium 175 may be an optical fiber that is doped with rare-earth-elements such as, for example, neodymium (Nd³⁺), erbium (Er³⁺), ytterbium (Yb³⁺), praseodymium (Pr3+), or thulium (Tm3+). Because it is a fiber laser source, gain medium 175 may affect the distribution of photons within laser beam 195, and may affect an energy distribution of laser beam 195 to be more evenly distributed. As shown in FIG. 3, laser beam 195 may melt and weld edges 206 and 208 of work pieces 115 and 120.

### INDUSTRIAL APPLICABILITY

The disclosed welding system may be used in any process where welding is required. The disclosed welding system may be used in all industries using welding, including manufacturing, remanufacturing, and repair applications.

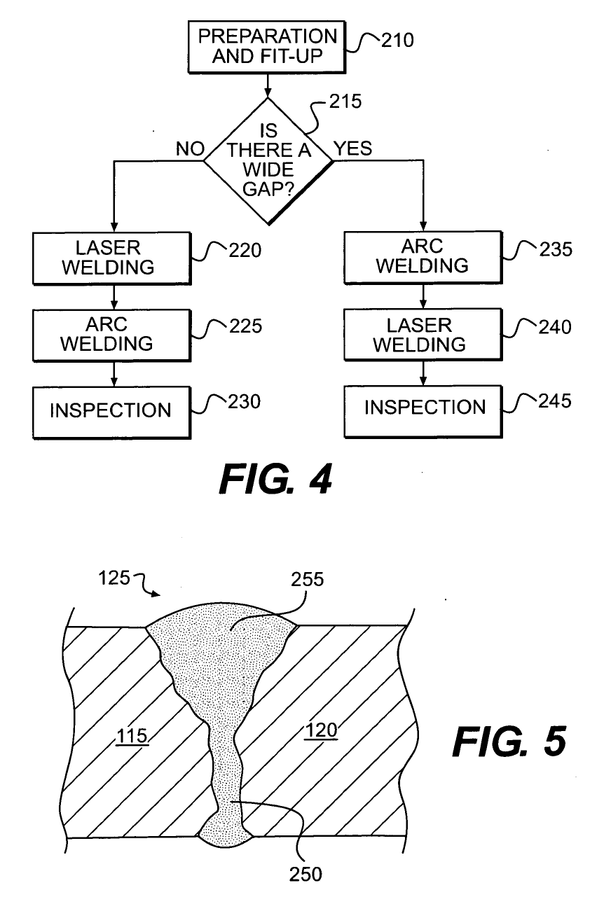

FIG. 4 illustrates a hybrid welding method. In step 210, preparation and fit-up of work pieces 115 and 120 may occur. Work pieces may be prepared by any suitable weld preparation technique such as, for example, laser cutting, shot-blasting, and machining. In step 215, an evaluation of the width of gap 130 and mismatch between work pieces 115 and 120 may be made. The width of gap 130 may be measured by any suitable method known in the art such as, for example, via a mechanical gage, or continuously during the welding process using camera 300. Gap 130 may be determined to be wide if it is greater than a threshold width such as, for example, between about ¼ mm and about ¾ mm. For example, the threshold width may be about ½ mm. If gap 130 is less than or equal to the threshold width, it may be determined to be narrow and steps 220, 225, and 230 may be followed.

In step 220, laser welder 105 may laser weld work piece 115 to work piece 120 at a desired location via laser beam 195. Laser beam 195 may melt and weld edges 206 and 208 of work pieces 115 and 120 together. As shown in FIG. 5, finished weld 125 may include a weld portion 250 made primarily from the laser welding of step 220.

Step 225 may occur within a very short time of step 220 such as, for example, between about 0 and 100 milliseconds. In step 225, arc welder 110 may weld edge 206 and edge 208, and add metal from electrode 140, to make weld 125 at the desired location. As shown in FIG. 5, finished weld 125 may include a weld portion 255 made primarily from the arc welding of step 225.

If gap 130 is greater than the threshold width, it may be determined to be wide and steps 235, 240, and 245 may be followed. When gap 130 is wide, the arc welding of step 235 may be performed prior to the laser welding of step 240. Steps 235 and 240 may be similar to steps 225 and 220, respectively. Steps 235 and 240 may produce a weld that is similar to finished weld 125 shown in FIG. 5.

Steps 230 and 245 may occur within a very short time of 225 and 240, respectively. This step may be conducted using camera 300 or a different inspection technology to inspect weld 125. Steps 230 and 245 evaluate the conformance of the resulting weld to the engineering requirements.

Welding system 100 may employ laser-arc hybrid welding to produce weld 125. Camera 300 may be used to perform adaptive welding to make adjustments to the position of laser welder 105, arc welder 110, and work pieces 115 and 120 during the welding process. Camera 300 may adjust welding system 100 to account for mismatch of work pieces 115 and 120 and gap 130. Gain medium 175 may be a fiber laser source that produces laser beam 195 that produces weld 125 without voids. Laser beam 195 may melt edges 206 and 208 instead of shooting through gap 130. Using a fiber laser source may also produce an energy distribution more efficiently, thereby reducing costs.

It will be apparent to those skilled in the art that various modifications and variations can be made to the disclosed welding method. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A welding method, comprising:
making a weld via laser-arc hybrid welding; and
using a fiber laser source in the laser-arc hybrid welding.

2. The method of claim 1 wherein a position of an arc welder and a position of a laser welder are varied during a welding process to generally match a change in position of a plurality of work pieces to be joined.

3. The method of claim 1 wherein a programming of an arc welder and a programming of a laser welder are adjusted during a welding process based on a change in position of a plurality of work pieces to be joined.

4. The method of claim 1, wherein the laser-arc hybrid welding includes laser welding occurring within between about 0 and 100 milliseconds of arc welding at a desired location.

5. The method of claim 4, further including continuously monitoring the weld with a camera.

6. The method of claim 1, wherein the fiber laser source is an optical fiber that is doped with a rare-earth-element.

7. The method of claim 6, wherein the rare-earth-element is neodymium, erbium, ytterbium, praseodymium, or thulium.

8. The method of claim 1, wherein the laser-arc hybrid welding moves at a rate of between about 1 and 2 meters/minute.

9. A welding system, comprising:
a laser-arc hybrid welder including a laser welder coupled to an arc welder; and
the laser welder includes a fiber laser source.

10. The welding system of claim 9, wherein the fiber laser source is an optical fiber that is doped with a rare-earth-element.

11. The welding system of claim 10, wherein the rare-earth-element is neodymium, erbium, ytterbium, praseodymium, or thulium.

12. The welding system of claim 9, wherein the laser welder has a power level of between about 4 and 20 kW.

13. The welding system of claim 9, wherein a wire-to-laser-beam distance of the laser-arc hybrid welder is between about 0 and 20 mm.

14. The welding system of claim 9, further including a camera that measures a mismatch of a plurality of work pieces.

15. The welding system of claim 9, wherein the arc welder is a gas metal arc welder positioned at an angle of between about 20 and 45 degrees from an axis perpendicular to a work piece.

16. A welding method, comprising:
laser welding a first element to a second element at a desired location, the laser welding using a fiber laser source; and
arc welding the desired location following the laser welding, the laser welding and arc welding together making a butt-weld.

17. The welding method of claim 16, wherein the fiber laser source is an optical fiber that is doped with a rare-earth-element.

18. The welding method of claim 17, wherein the rare-earth-element is neodymium, erbium, ytterbium, praseodymium, or thulium.

19. The welding method of claim 16, wherein a gap between the first and second elements is less than or equal to about ½ mm.

20. The welding method of claim 16, wherein the first and second elements are between about 6 and 12 mm thick.
